(19) United States
(12) Patent Application Publication
(10) Pub. No.: US 2004/0078788 A1
(43) Pub. Date: Apr. 22, 2004

(54) Metamodel for IDL to XML parsing and translation

(76) Inventor: Candy Wai-See Wong, Richmond Hill (CA)

Correspondence Address: REDKNEE INC., 2560 MATHESON BLVD. EAST, SUITE 500, MISSISSAUGA, ON, L4W4W9, CA

(21) Appl. No.: 10/271,993

(22) Filed: Oct. 17, 2002

(51) Int. Cl. G06F 9/45

(52) U.S. Cl. 717/140; 717/114; 717/118; 717/136

(57) ABSTRACT

Among developers and the software industry as an aggregate, there exists a pressing need for a utility which converts the interface definition specified in IDL format to an Extensible Markup Language (XML) format. Indeed, as an unstructured definition language, the Common Object Request Broker Architecture (CORBA) IDL is well suited and particularly effective for describing data structures and interfaces, though, the existing state of the art remains constrained and limited in extracting this information for further manipulation. The Metamodel for IDL to XML Parsing and Translation invention employs the IDL-to-Java (IDLJ) utility common to Sun's™ Java™ Development Kit. The Metamodel innovatively goes beyond the existing art and harnesses the IDL parsing ability of the IDLJ and generates an XML output for the parsed contents. For ease of XML manipulation, the Metamodel for IDL to XML Parsing and Translation utilizes the JDOM library to store and output the said XML.

### BACKGROUND ART

The Interface Definition Language (IDL) generally specified by the Object Management Group and other organizations defines a language used to describe the interfaces that client objects call and object implementations provide. An interface definition written in Interface Definition Language (IDL) completely defines the interface and fully specifies each operation's parameters. An IDL interface provides the information needed to develop clients that use the interface's operations. Clients are not written in IDL, which is purely a descriptive language, but in languages for which mappings from IDL concepts have been defined. The mapping of an IDL concept to a client language construct will depend on the facilities available in the client language. For example, an IDL exception might be mapped to a structure in a language that has no notion of exception, or to an exception in a language that does.

Among developers and the software industry as an aggregate, there exists a pressing need for a utility which converts the interface definition specified in IDL format to an Extensible Markup Language (XML) format. Indeed, as an unstructured definition language, the Common Object Request Broker Architecture (CORBA) IDL is well suited and particularly effective for describing data structures and interfaces, though, the existing state of the art remains constrained and limited in extracting this information for further manipulation. And, while there has been much discussion regarding the development of such a utility, little ground has been laid in terms of actual implementation or follow-through. For instance, the T15 Department of the Technische Universität Hamburg-Harburg (http://www.ti5.tu-harburg.de/) has published a report on an IDL2XML Compiler (http://www.ti5.tu-harburg.de/Publication/1998/reports/idl2xml/default.htm), though the implementation thereof remains materially dissimilar to that disclosed herein.

Additionally, the resulting XML which the Metamodel generates represents an atypical and original variation on the IDL XML schema proposed by Rene Moller Fonseca of the University of Southern Denmark (http://www.mip.sdu.dk/˜fonseca/idl).

### REFERENCES CITED

Other References

Interface Definition Language—Allocation of XML namespace. René Møller Fonseca, Online: http://www.mip.sdu.dk/˜fonseca/idl/

IDL2XML Compiler—Department of the Technische Universität Hamburg-Harburg, Online:

http://www.ti5.tu\harburg.de/Publication/1998/reports/idl2xml/default.htm

### TECHNICAL FIELD

The present invention speaks generally to computer languages, and specifically to a method, system and utility directed towards transforming Common Object Request Broker Architecture (CORBA) Interface Definition Language (IDL) definitions to an Extensible Markup Language (XML).

### SUMMARY OF THE INVENTION

In curing the deficiencies of the existing art, the invention of present seeking the protection of Letters Patent was developed to transform (CORBA) Interface Definition Language (IDL) definitions to an Extensible Markup Language (XML).

The Metamodel for IDL to XML Parsing and Translation employs the IDL-to-Java (IDLJ) utility common to Sun's™ Java™ Development Kit. The Metamodel innovatively goes beyond the existing art and harnesses the IDL parsing ability of the IDLJ and generates an XML output for the parsed contents. For ease of XML manipulation, the Metamodel for IDL to XML Parsing and Translation utilizes the JDOM library to store and output the said XML.

And although some elements of the present art borrow from and/or rely upon existing third party methods, means and related information, it is respectfully submitted that the novelty of the invention remains in its juxtaposition, incorporation and/or extrapolation of fresh ideas, elements and means well beyond any said anticipation of the existing art.

### BRIEF DESCRIPTION OF THE DRAWINGS

FIG. 1 represents an illustrative block diagram of the Metamodel for IDL to XML Parsing and Translation.

### DETAILED DESCRIPTION OF THE PREFERRED EMBODIMENTS

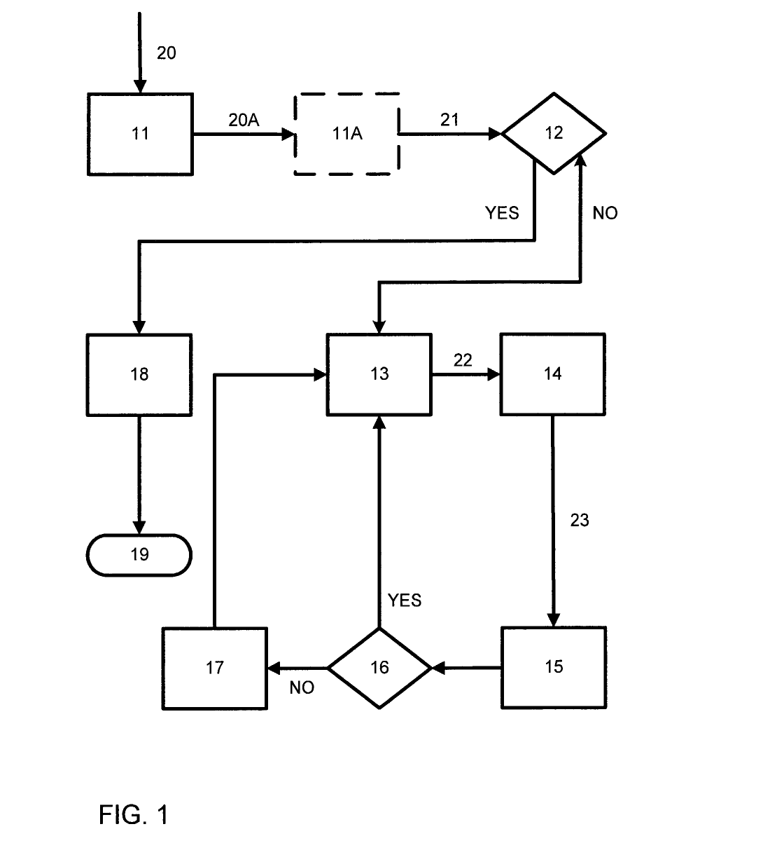

Now in reference to FIG. 1, a CORBA IDL file 20 is input into the parsing and translation metamodel which builds factories of XML generators 11 to handle different types of symbols found in IDL files. Each of these XML generators 11 is responsible for using the information from the parsed IDL file to build a fragment of XML representing the same information.

The parsing and translation metamodel then invokes the inherited IDL parser from Sun's™ Java™ Development Kit 11A to parse the existing CORBA IDL file (now 20A for clarity sake) into a stack of parsed symbols called the Emit List 21.

At 12 the parsing and translation metamodel determines whether said Emit List 21 is empty or not. Where said Emit List 21 remains non-empty, the metamodel removes entries thereof one by one for processing 13. Based on the type of the entry 22, a corresponding XML generator is used to generate an XML fragment for the entry 14 and inserts said fragment into the XML tree in memory 15. The XML fragments and tree are stored in memory as JDOM objects 23.

At 16 the parsing and translation metamodel asks whether said XML generation was in fact successful, if not, a generation error is output 17 and the operation continues.

When all entries in the Emit List 21 are processed 12, the parsing and translation metamodel should have a complete XML tree 18 representing the same information as the original IDL file 20. In completing the operation, said parsing and translation metamodel invokes JDOM's XML Outputter to output the XML tree to a file 19.

What is claimed is:

1. A metamodel for parsing and translating CORBA IDL definitions to XML.

2. The method of claim 1, whereby CORBA refers to a Common Object Request Broker Architecture.

3. The method of claim 1, whereby IDL refers to an Interface Definition Language.

4. The method of claim 1, whereby XML refers to an Extensible Markup Language.

5. The method of claim 1, comprising a computer program product for implementing said metamodel on a computer readable memory medium and a computer program including instructions for parsing and translation.

6. The method of claim 5, which invokes an inherited IDL parser from Sun's Java Development Kit.

7. The method of claim 5, wherein the metamodel builds factories of XML generators to handle different types of symbols found in IDL files.

8. The method of claim 7, whereby each XML generator is responsible for using the information from the parsed IDL file to build a fragment of XML representing the same information.

9. The method of claim 6, whereby the CORBA IDL file is parsed into a stack of symbols (‘Emit List’).

10. The method of claim 9, which invokes an inherited IDL parser from Sun's Java Development Kit.

11. The method of claim 9, whereby the metamodel removes entries from the said Emit List piecemeal for processing. Based on the type of the entry, a corresponding XML generator is used to generate an XML fragment for the entry and insert that fragment into the XML tree in memory.

12. The method of claim 11, where XML fragments and tree are stored in memory as JDOM objects.

13. The method of claim 9, whereof all entries in the Emit List are processed and exhausted.

14. The method of claim 13, where a complete XML tree representing the same information as the original IDL file is produced.

15. The method of claim 14, where said metamodel invokes JDOM's XML Outputter to output the XML tree to a file.
